(19) United States
(12) Patent Application Publication
(10) Pub. No.: US 2008/0314877 A1
(43) Pub. Date: Dec. 25, 2008

(54) Plasma Keyhole Welding of Hardenable Steel

(76) Inventors: Rolf Cremerius, St. Augustin (DE); Thomas Pullen, Aachen (DE)

Correspondence Address: Dickinson Wright PLLC, 38525 Woodward Avenue, Suite 2000, Bloomfield Hills, MI, 48304, US

(21) Appl. No.: 10/562,802

(22) PCT Filed: Nov. 5, 2004
(86) PCT No.: PCT/EP2004/012518

§ 371 Date: Nov. 15, 2006

(51) Int. Cl. B23K 9/00

(52) U.S. Cl. 219/121.46

(57) ABSTRACT

The invention describes a process for producing a weld seam (1) in hardenable steel (2) having a material thickness (3) without secondary heating, comprising at least the following steps:
a) positioning a welding electrode (4) with respect to a weld line (5);
b) applying a voltage;
c) supplying a plasma gas (6);
d) forming an arc (7);
e) melting the steel (2) in the vicinity of the weld line (5) over the entire material thickness (3).

This process is preferably used to join components for torque transmission in motor vehicles.

The invention relates to a process for producing a weld seam in hardenable steel with a predetermined material thickness without secondary heating. In particular, the invention also describes a process for joining components for torque transmission in a motor vehicle made from hardenable steel by producing a weld seam. Further subjects of the invention are joins and vehicles which comprise joins between components for torque transmission made from hardenable steel. A preferred application area for the invention is weld seams of drive train components used in the automotive industry.

What are known as carbon steels with a carbon content of at least 0.25% and low alloy steels with a carbon content of over 0.2% are of only limited suitability for conventional welding (referred to below in general as “hardenable steels” or “steels which can be hardened directly, in particular not just by case hardening”). The reason for this lies in the surface hardening in the weld seam and the heat-affected zone, which is caused by the carbon, is exacerbated by various alloying elements and leads to cracks. The surface hardening and subsequent formation of cracks comes about as a result of the formation of relatively undeformable martensite or bainite which has not undergone any self-tempering or has only undergone a small amount of self-tempering and is not capable of plastically breaking down the high stresses which occur during cooling. High cooling rates, increasing carbon contents and/or alloying element contents promote this surface hardening and hardness depth.

Hitherto, opinion has been that conventional welding processes or gas welding processes, on account of their relatively low power density, lead to relatively low heating rates, large-area introduction of heat and bulky weld seams. It has therefore been assumed that the use of a beam welding process, such as laser or electron beam welding, is the only process which can be used to form joins between hardenable steels, on account of the higher power density. A beam welding process of this type is disclosed, for example, by EP 0 925 140 B1.

However, a common feature of all known attempts relating to the beam welding of hardenable steels is that the components are thoroughly preheated to the region of 400° C. or above. The intention of this is to prevent any type of self-quenching of the hardenable steel, resulting in the formation of cracks, on account of rapid cooling. However, these processes with preheating are technically more complex, for example apparatuses for inductively heating the components have to be integrated in the processing stations and the welding process has to be readjusted.

In particular in connection with components of the drive train made from hardenable steel in the automotive industry, therefore, there is a constant problem with providing a welding process which, in mass terms, provides an energy per unit length of weld which is sufficient to achieve a high-quality, usable and robust weld seam. This means in particular that torsionally rigid joining of shafts or similar components is to be realized; this joining process should be suitable for integration in flow line manufacture. Furthermore, the welding process should be as inexpensive and uncomplicated as possible with regard to handling. Moreover, it would be advantageous if it were possible to specify a welding process which is flexible with regard to possible component geometries and/or different configurations of the weld seams. The joins produced by the process should in particular satisfy the demands imposed in the automotive industry.

It is an object of the present invention to at least partially alleviate the problems which have been described in connection with the prior art and/or to at least partially realize the objectives mentioned above. In particular, it is intended to describe a gas welding process which ensures crack-free joining of components made from hardenable steel. The gas welding process should preferably provide joins between components of a drive train of a motor vehicle which satisfy the demands imposed in the automotive industry.

These objects are achieved by a process for producing a weld seam having the features of Patent Claim 1 and Patent Claim 2. Preferred configurations of the process and joins between at least two components for torque transmission produced by the process, as well as associated vehicles, are described in the dependent patent claims. It should be noted that the features listed in the patent claims can be combined with one another in any technologically appropriate way. Moreover, the combinations described in the patent claims can be characterized in more detail by features of the description.

The process according to the invention for producing a weld seam in hardenable steel having a material thickness without secondary heating comprises at least the following steps:
a) positioning a welding electrode with respect to a weld line;
b) applying a voltage;
c) supplying a plasma gas;
d) forming an arc;
e) melting the steel in the vicinity of the weld line over the entire material thickness.

A “weld seam” is to be understood as meaning a resolidified region of the hardenable steel which has previously been brought into a molten state as a result of the action of heat from the arc. The weld seam may include further constituents, in particular if a filler is used to produce the weld seam. The weld seam substantially follows a desired weld line. In other words, the “weld line” is to be understood as meaning the final profile of the weld seam.

In accordance with step a), the welding electrode is positioned or aligned with respect to the weld line. It is in this context irrelevant whether the welding electrode is aligned with respect to the component or vice versa. The welding electrode is preferably a tungsten electrode. This welding electrode is connected to a starting device or a welding energy source. Then, in accordance with step b), a voltage is applied. It is in principle possible for the voltage to be formed between parts of the welding torch itself, so as to produce what is known as a “non-transmitting” arc. It is however preferred in the present case to form a “transmitting” arc, in which case a voltage is provided between the welding electrode and the component made from hardenable steel. Transformers, rectifier assemblies, pulse generators, etc. can be used to provide the desired welding voltage. Next, in accordance with step c), plasma gas is supplied. It is preferable for the plasma gas likewise to be supplied using the welding torch, in which case the plasma gas advantageously flows out centrally and in the immediate vicinity of the welding electrode. Then, an arc is formed (step d)). On account of the interaction between plasma gas and arc, a concentrated, high-energy introduction of heat into the components made from hardenable steel is ensured. In accordance with step e), as a consequence of this introduction of heat, the hardenable steel is then melted over the entire material thickness in the vicinity of the weld line. This makes use in particular of what is known as the “keyhole effect”. In this case, the plasma jet melts the material over its entire depth, so as to form a keyhole. During welding, the plasma jet moves with the keyhole along the abutting edges. Behind the plasma jet, the molten metal flows back together on account of the surface tension of the molten pool and the vapour pressure in the keyhole, thereby forming the weld seam.

During the plasma keyhole welding proposed here, energy is introduced into the hardenable steel to such an extent that self-quenching or undesirable surface hardening of the material does not occur. Therefore, for the first time, a welding process is proposed which uses electrical gas discharge (plasma welding) on the one hand to realize a concentrated, high-energy introduction of heat without secondary heating and on the other hand at the same time to avoid major component distortion as a result of large-area introduction of heat. Despite the concentrated, high-energy introduction of heat, the heat distribution and heat management can be set in such a way that the cooling gradients do not enter the critical range, as occurs for example when using laser or electron beam welding. Consequently, there is no need for secondary heating before, during or after the welding operation, and crack-free weld seams can be obtained.

With regard to the “crack-free” configuration of the weld seam, it should be explained that this form of join does not include any macro-cracks, as they are known, i.e. cracks of a size which is such that they are visible to the naked eye. Smaller micro-cracks, as they are known (the length of these cracks is often only in the region of a grain diameter of the material, and they can only be perceived by microscopic (metallographic) methods) in this case also only occur to an acceptable extent. In the present context, a “crack” is in particular a limited material separation with a predominantly two-dimensional extent, which may occur in the weld metal, in the heat-affected zone and/or in the base metal, in particular on account of internal stresses. A “crack” needs to be distinguished, for example, from cavities, gas inclusions, pores, voids, solid inclusions and/or other defects in a weld seam. Although the defects in a weld seam which are distinct from cracks should of course also be avoided as far as possible, in the present context, the primary objective is freedom from (macro-)cracks, since cracks are the most dangerous and widespread form of defect, making subsequent repair imperative. This has also been the reason over the course of many years why steels with a high carbon content, which for example are subject to considerable stresses in use, have only been welded with secondary heating.

A further aspect of the present invention proposes a process for joining components for torque transmission in a vehicle made from hardenable steel and having a material thickness by producing a weld seam without secondary heating, which comprises at least the following steps:
a) positioning a welding electrode with respect to a weld line;
b) applying a voltage;
c) supplying a plasma gas;
d) forming an arc;
e) melting the steel in the vicinity of the weld line over the entire material thickness.

The process proposed here is a special application for the welding process described above. In this context, the welding process is used for joining components for torque transmission in a vehicle. On account of the high stressing of the components in use, particular specifications with regard to the quality of the weld seam, the dimensional accuracy, etc. need to be complied with. In this context, a weld seam is implemented in particular as a square butt weld, in which the components to be joined are placed so as to abut one another. The weld seam itself may be designed as a radial and/or axial seam. It is in this way preferable to weld a radial circumferential seam without root protection. The weld seam is free of cracks and extreme undercuts and corresponds to common conceptions with regard to weld and root reinforcement, which is to be understood as meaning the subregions of the weld seam which in each case project above the original surface of the parts to be joined. The roots of the weld seam are in this case formed on that side of the weld seam which lies on the side of the components remote from the welding electrode. In this context, it is also preferable for angle errors (for example caused by partial, time-offset shrinkage during solidification) to be kept in the range of less than 0.5% even in series production. At the same time, it is easily possible to prevent the components from being offset with respect to one another during the joining process, so that an offset of less than 0.2 mm can be ensured. This welding process enables the item costs of the welded components of the drive train of vehicles to be kept at a low level, since there is no need for long weld preparation work and/or component remachining work.

According to a refinement of the process, the hardenable steel has a material thickness in the range from 2.0 mm to 10.0 mm. The range is preferably from 2.0 mm to 8.0 mm, and in particular the range is from 4.0 mm to 6.0 mm. In the case of hardenable steels with this material thickness, it is possible to realize the “keyhole effect” in a reliable way, so that the desired introduction of energy and/or the desired formation of the weld seam is ensured. In particular with the material thicknesses indicated here, it is proposed that the energy per unit length introduced by the welding process be in the range from 234 J/mm to 3360 J/mm [Joules per millimetre]. Therefore, the energy per unit length introduced is, for example, considerably higher than in the case of beam welding, such as for example in a CO₂ laser. In the case of plasma keyhole welding, the energy per unit length is preferably in a range which is at least a factor of four higher than in the case of a CO₂ laser at the same welding speeds.

Furthermore, it is proposed that the weld seam be of single-layer design. It is in this case preferable for the components made from hardenable steel that are to be joined also not to be locally fixed, in particular tacked, beforehand. Carrying out single-layer welding leads to a very uniform formation of the weld seam, so that asymmetrical seam geometries which occur for example in the case of multi-layer welds, and resulting angle distortions, can be avoided. The single-layer through-welding, on account of its seam depth, seam width and seam shape, generates transient tensile stresses to an extent which is such that, in combination with the sufficient ductility of the material, these stresses do not lead to cracks. Producing a single-layer through-welding, which on account of its seam depth, seam width and seam shape and the resultant locally limited introduction of heat generates transient tensile stresses to this extent, has the advantage that only very minor component distortion occurs.

According to a refinement of the process, the weld seam is designed as a butt seam or a fillet seam. With regard to the design as a butt seam, it should be noted that this is used in particular in components for torque transmission. On account of the fact that the proposed welding process can be used to weld hardenable steels without major technical outlay and in particular without secondary heating, it has particular benefits with regard to seam geometries which are relatively inaccessible, such as for example a fillet seam. Moreover, on account of the uneven material distribution of the components during the welding process, it is difficult to realize suitable secondary heating. These difficulties are avoided with the welding process according to the invention.

The process in which a plasma jet, during the welding operation, is moved in the welding direction at a speed of at least 0.2 m/min [meters per minute] is particularly preferred. It is even preferable for the welding speed to be above 0.5 m/min. It is very particularly preferable for the welding speed not to exceed a value of 5.0 m/min.

In particular at the welding speeds proposed here, a welding current of at least 170 A [amperes] is applied. It is preferable for the welding current not to exceed a limit of 400 A. A process in which the plasma jet, during the welding operation, in the welding direction effects an energy per unit length of weld whose upper limit is set in such a way that the strength of the weld seam is above that of the adjoining components, is particularly preferred. The lower limit is preferably set in such a way that it is possible to ensure a sufficient ductility of the weld seam, which is limited by weld seam hardnesses of at most 650 HV.

The configuration of the process in which the weld seam is produced by radial circumferential welding is particularly preferred. This applies in particular with regard to the joining of components for torque transmission in a vehicle made from hardenable steel. This is to be understood in particular as a variant of the welding process in which a circumferentially continuous weld seam is produced for hollow profiled sections. The arc is in this case moved radially around the component or components. A process of this type is recommended, for example, for the end-side joining of hollow shafts or similar components.

The invention now also proposes a join between at least two components for torque transmission made from hardenable steel, the join comprising at least one weld seam produced by one of the processes according to the invention as mentioned above. The join between these two components can be used, for example, for torque transmission in drive systems of a car. This creates the possibility of the components subsequently (i.e. in the joined state) also being fed to a hardening process, in order to withstand the in particular static stresses prevailing there. On account of the avoidance of secondary heating, filler and the like while at the same time achieving a high-quality weld seam, a join of this type is simple and inexpensive to produce in particular even in series production.

A join produced by a process described in accordance with the invention, in particular plasma keyhole welding, can for example be clearly recognized, by virtue of the fact that the weld seam is in single-layer form and accordingly is generally designed with an aspect ratio (V_{A}) of depth to width of the weld seam of approx. 1.0:1.5 to approx. 1.0:2.0 (in particular in the range V_{A}=1.0:1.2 to 1.0:1.8). The width of the heat-affected zone based on the centre of the weld seam is greater than that of a beam weld (using laser V_{A} is approximately 2.5:1.0) but significantly smaller than that of a manual electrode or gas weld (when using MIG welding processes, V_{A} is approximately 1.0:3.0).

A join of this type has proven advantageous in particular if at least one of the components is a hollow shaft with a wall thickness in the range from 2.0 mm to 10.0 mm. It is very particularly preferable for the hollow shaft to have a wall thickness in the range from 2.0 mm to 8.0 mm, and in particular in the range from 4.0 mm to 6.0 mm. These hollow shafts are preferably propshafts or sideshafts of a car.

It is also proposed that the join and adjoining subregions of the components be of crack-free design. With regard to the applicable meaning of “crack-free” in this context, reference is made to the statements given above in this context. This in particular allows high dynamic, long-term cyclic stresses and static torsional stresses on the join. For example, joins of this type withstand a dynamic long-term cyclic stressing of 300,000 oscillation cycles at a torque of ±1100 Nm and 1650 Nm [Newton meters]. With regard to the static torsional stressing, the fracture torque is at least 3200 Nm.

According to an advantageous configuration of the join, the latter has a ductility in the range from 250 HV to 650 HV. This is to be understood as meaning that the join or the weld seam leads to the abovementioned result in a Vickers hardness test method. In this context, it is advantageous for the ductility in the region of the weld seam and the heat-affected zone to be above the component in the normal state. In this context, it is preferable for the ductility to be in a range up to approximately 500 HV.

It is also possible for the join to have a martensitic microstructural content of at most 30% in the region of the weld seam and a heat-affected zone. This can be used in particular as a measure for setting the corresponding energy per unit length for the hardenable steel which is to be welded in each instance. Restricting the martensitic microstructural content as proposed here can ensure that the internal stresses in the microstructure are so low that no (macro-)cracks are formed.

As has already been mentioned a number of times, the preferred use of the process and the join is in the automotive industry. For this reason, the invention also proposes a vehicle comprising an engine with a drive system, the drive system having components for torque transmission, and at least two components having been welded together by a process according to the invention, or the vehicle including a corresponding join.

Examples of a corresponding joining arrangement:

Process:

| | |
|---|---|
| Material component A: | Tube made from Ck 35, |
| | 70 mm diameter |
| Wall thickness component A: | 5.0 mm |
| Material component B: | Tube made from Cf 53, |
| | 70 mm diameter |
| Wall thickness component B: | 6.0 mm |
| Welding current: | 280 A |
| Feedrate: | 0.5 m/min |

Join:

| | |
|---|---|
| Dimensions of the weld | 6.0 mm depth, |
| seam: | 3.0-5.0 mm top bead |
| Ductility: | 250-650 HV |
| Load tests: | dynamic: 300,000 |
| | oscillation cycles |
| | ±1100 Nm |
| | static: |
| | fracture torque >3200 Nm |
| Optical test result | crack-free |

The invention and the technical background are explained in more detail below with reference to the figures. In this context, it should be noted that the figures show particularly preferred exemplary embodiments of the invention, but without the invention being restricted to these embodiments. The illustrations in the figures are diagrammatic and are not generally suitable for representing dimensions. In the drawing:

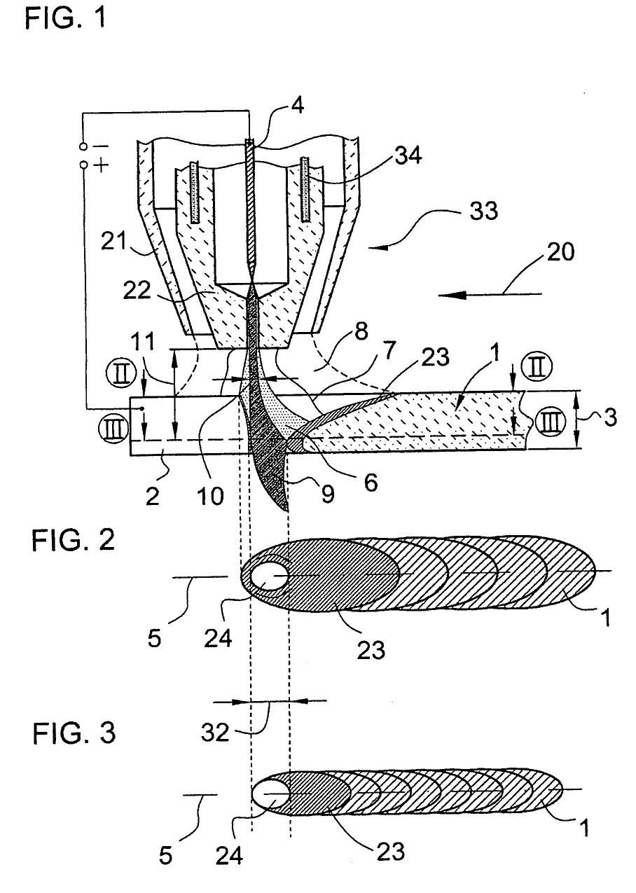

FIG. 1 diagrammatically depicts the structure of a welding torch during the welding operation;

FIG. 2 shows a weld seam in the vicinity of the weld seam surface;

FIG. 3 shows the weld seam in the vicinity of the weld seam root;

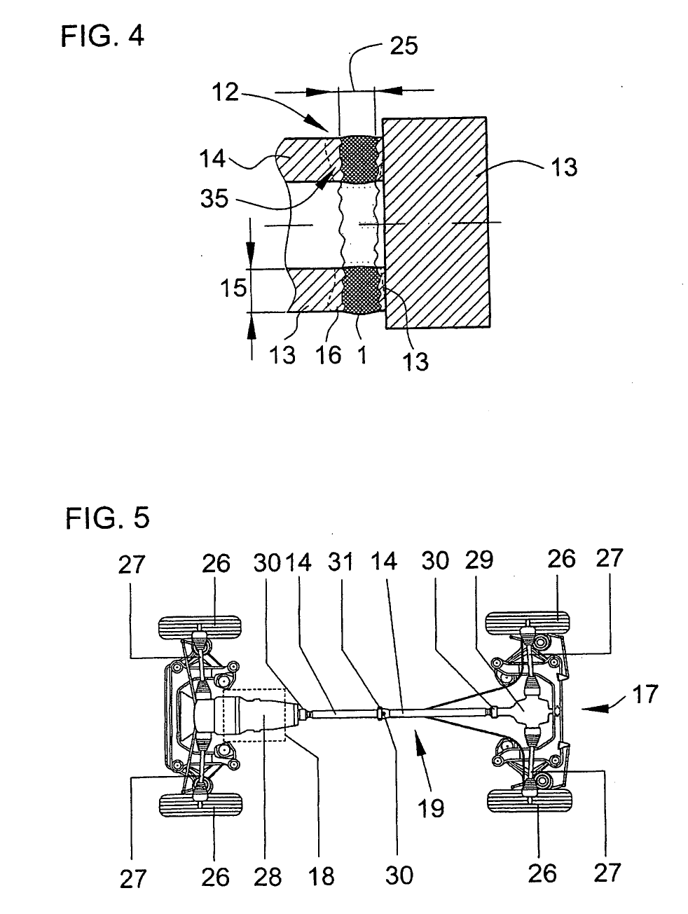

FIG. 4 diagrammatically depicts a variant embodiment of a join in cross section through joined components; and

FIG. 5 diagrammatically depicts a drive system of a vehicle.

The illustrations in the figures are diagrammatic and can only represent the actual proportions to a limited extent.

FIG. 1 shows a diagrammatic and cross-sectional view of a welding torch 33 for carrying out the process according to the invention. The welding torch 33 is formed with a welding electrode 4 which is arranged centrally with respect to the welding torch. The welding electrode 4 made from tungsten is surrounded by a plasma nozzle 22 which includes water cooling 34. During the welding operation, plasma gas 6 is supplied via the plasma nozzle 22. A shielding gas nozzle 21 (preferably made from copper) is provided concentrically with respect to the plasma nozzle 22. During the welding process, shielding gas 8 flows out through an annular gap formed around the plasma nozzle 22, and this shielding gas 8, on account of its thermal conductivity, leads to constriction of the arc 7 or the plasma jet 9. As a result, the plasma jet 9 can be guaranteed to have a relatively small diameter 10 even over a great length 11.

To carry out the process for producing a weld seam 1 in hardenable steel 2 with a material thickness 3 in the range from 2.0 mm to 10 mm, first of all the welding electrode 4 is positioned with respect to a weld line 5 (not illustrated). To realize the plasma arc welding process variant, a voltage is applied between the tungsten electrode (negative pole) and the hardenable steel (positive pole). Then, shielding gas 8 and plasma gas 6 are delivered to the welding location through the nozzle, and an arc 7 is formed between the welding electrode 4 and the hardenable steel 2. On account of the high temperature, the steel 2 is melted over the entire material thickness 3 in the vicinity of the weld line 5. In the variant embodiment illustrated, this gives rise to what is known as the “keyhole effect”, whereby the plasma jet 9 penetrates through the hardenable steel 2 over the entire material thickness 3, so as to form a keyhole 24. The keyhole 24 has a width 32 which is set, for example, as a function of the feed rate.

During welding, the plasma jet 9 moves with the keyhole 24 in the welding direction 20. Behind the plasma jet 9, the molten metal flows back together on account of the surface tension of the molten pool and the vapour pressure in the keyhole 24, thereby forming the weld seam 1.

To illustrate the formation of the weld seam, FIG. 2 and FIG. 3 show cross sections through the weld seam 1 at different levels, as correspondingly marked in FIG. 1. FIG. 2 shows a relatively wide weld seam 1 and a relatively large molten pool 23 as seen from above. By contrast, FIG. 3 illustrates a region remote from the surface of the hardenable steel 2, for example in the region of the smallest width 32 of the keyhole 24. The weld seam 1 in each case follows the desired weld line 5.

FIG. 4 diagrammatically depicts a cross section through a welded join 12 which has been produced by the process described. The join 12 is designed as a continuous weld seam 1 with respect to two components 13 arranged adjacent to one another. Both components 13 have a rotationally symmetrical hollow profile; the component 13 illustrated on the left is designed as a hollow shaft 14. The right-hand component 13, moreover, is fixed to a further, solid component 13, which has a considerable influence on the dissipation of heat in the subregions 16 to be welded of the weld seam 1. At least the two components 13 with a hollow profile comprise a hardenable steel.

To form the weld seam 1, the components 13 are heated in the subregions 16 by a plasma jet 9 or an arc 7 (neither of which is illustrated) in such a way that the steel is at least partially converted into a molten state. In addition to the region of the weld seam 1, what is known as a heat-affected zone 35 can also be recognized. The weld seam 1 was designed as a radial circumferential weld, which extends over the entire wall thickness 15 of the components 13 with a width 25 in the range from 2.0 mm to 5.0 mm.

FIG. 5 reveals a drive system 19 for a four-wheel-drive vehicle 10. In this case, all four wheels 26 are driven by an engine 18. An engine transmission 28 can be seen in the region of the front axle and beneath the engine 18 which is also indicated. What is known as an axle transmission 29 is provided in the region of the rear axle. Sideshafts 27 are used to drive the wheels 26. The connection between the engine transmission 28 and the axle transmission 29 is provided by a propshaft arrangement which comprises two hollow shafts 14. This arrangement is additionally mounted on the underbody of the vehicle 17 by an approximately centrally arranged intermediate bearing 31. In a first propshaft portion, the propshaft arrangement has a first joint 30, arranged in the vicinity of the engine transmission 28, in the form of a constant-velocity fixed joint. To connect the two propshaft portions or hollow shafts 14, a second joint 30 is provided in the centre in the form of a constant-velocity fixed joint. At the end of the second propshaft portion of the hollow shaft 14 shown on the right, there is a third joint 30 in the form of a constant-velocity fixed joint which is connected to the axle transmission 29 via connecting means. The hollow shafts 19 or propshaft portions in most applications rotate at a rotational speed which is above the rotational speed introduced into the manual or automatic transmission by the engine 18. The transmission ratio is stepped down in the region of the axle transmission 29. Whereas, for example, the hollow shafts 14 and the associated joints 30 have to execute rotational speeds of up to 10,000 revolutions per minute, the rotational speeds of the sideshafts 27 for operation of the wheels 26 are of the order of magnitude of up to 2,500 revolutions per minute.

The join according to the invention is preferably used for the following components:
Propshaft system components which are joined, such as for example:
   Tubular shaft/solid shaft
   Tubular shaft/joint outer part
   Tubular shaft/journal
   Tubular shaft/joint inner part (e.g.: hub)
   Joint outer part/housing cover
   Joint outer part/flange/e.g. transmission flanges
   Joint disc/joint base
   Sliding sleeve/shaft journal
Differential/transmission systems
   Gear/gear
   Tubular shaft/gear
   Housing/housing cover
   Journal/housing cover

### LIST OF DESIGNATIONS

1 Weld seam
2 Steel
3 Material thickness
4 Welding electrode
5 Weld line
6 Plasma gas
7 Arc
8 Shielding gas
9 Plasma jet
10 Diameter
11 Length
12 Join
13 Component
14 Hollow shaft
15 Wall thickness
16 Subregion
17 Vehicle
18 Engine
19 Drive system
20 Welding direction
21 Shielding gas nozzle
22 Plasma nozzle
23 Melt
24 Keyhole
25 Width
26 Wheel
27 Sideshaft
28 Engine transmission
29 Axle transmission
30 Joint
31 Intermediate bearing
32 Width
33 Welding torch
34 Water cooling
35 Heat-affected zone

1. (canceled)

2. A process for joining components for torque transmission in a vehicle, the components being made from hardenable steel and having a material thickness, by producing a weld seam without secondary heating, comprising:
positioning a welding electrode with respect to a weld line;
applying a voltage;
supplying a plasma gas;
forming an arc; and
melting the steel in the vicinity of the weld line over the entire material thickness.

3.-12. (canceled)

13. A process according to claim 2, wherein the hardenable steel has a material thickness in the range from approximately 2.0 mm to 10.0 mm.

14. A process according to claim 2, wherein the weld seam is of single-layer design.

15. A process according to claim 13, wherein the weld seam is of single-layer design.

16. A process according to claim 2, wherein the weld seam is a butt seam or a fillet seam.

17. A process according to claim 13, wherein the weld seam is a butt seam or a fillet seam.

18. A process according to claim 2, wherein during the welding operation, a plasma jet is moved in the welding direction at a welding speed of at least 0.2 m/min.

19. A process according to claim 13, wherein during the welding operation, a plasma jet is moved in the welding direction at a welding speed of at least 0.2 m/min.

20. A process according to claim 2, wherein the weld seam is produced by radial circumferential welding.

21. A join between at least two components for torque transmission made from hardenable steel, wherein the join comprises at least one weld seam produced by a process according to claim 2.

22. A join according to claim 21, wherein at least one of the components is a hollow shaft with a wall thickness in the range from approximately 2.0 mm to 10.0 mm.

23. A join according to claim 18, wherein at least one of the components is a hollow shaft with a wall thickness in the range from approximately 2.0 mm to 10.0 mm.

24. A join according to claim 21, wherein the join and adjoining subregions of the components are essentially free of cracks.

25. A join according to claim 22, wherein the join and adjoining subregions of the components are essentially free of cracks.

26. A join according to one of claim 21, comprising a ductility in the range from about 250 HV to 650 HV.

27. A vehicle comprising an engine with a drive system, wherein the drive system includes components for torque transmission, and at least two components have been welded to one another by a process according to claim 2.

28. A vehicle comprising an engine with a drive system, wherein the drive system includes components for torque transmission, and at least two components have been welded to one another by a process according to claim 18.

29. A vehicle comprising at least two components made form hardenable steel and connected by a join comprising a weld seam produced by a process according to claim 2.

30. A vehicle comprising at least two components made form hardenable steel and connected by a join comprising a weld seam produced by a process according to claim 18.
